(19) United States
(12) Patent Application Publication
(10) Pub. No.: US 2005/0009406 A1
(43) Pub. Date: Jan. 13, 2005

(54) Switch terminal for memory card connectors

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 10/869,546

(22) Filed: Jun. 16, 2004

(30) Foreign Application Priority Data
Jun. 17, 2003 (TW) 92211040

(51) Int. Cl. G06K 7/06

(52) U.S. Cl. 439/638; 439/629

(57) ABSTRACT

A memory card connector includes an insulative housing having a rear terminal-mounting section and at least one side wall section extending forwardly from one end of the rear section and defining a card-receiving space therewith. A first switch terminal has a body portion fixed in the housing. A contact spring arm is cantilevered from the body portion. A card-engaging portion is located at a free end of the contact spring arm and is exposed in the card-receiving space for engaging by a memory card inserted thereinto. A first contact portion is bent back behind the card-engaging portion. A second switch terminal has a second contact portion. A third switch terminal has a pair of third contact portions engageable by the first and second contact portions of the first and second switch terminals, respectively, in response to inserting the memory card into the card-receiving space.

### FIELD OF THE INVENTION

This invention generally relates to the art of electrical connectors and, particularly, to a memory card connector having an improved switch terminal.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like.

Some memory card connectors are provided with a write-protection function by means of a pair of elastic conductive terminals forming a controlling switch. The two switch terminals are mounted at a side of the connector and have respective elastic arms arranged in close proximity to each other and may be moved into mutual engagement by the memory card to close the controlling switch. Some memory card connectors also are provided with a detector function by means of a pair of elastic conductive terminals forming a detector switch. The detector switch typically is at a rear of the connector and is actuated by a leading edge of a memory card to “detect” that the card has been fully inserted into the connector. Some memory card connectors have both a write-protection function and a card detector function, with a common or “third” conductive terminal forming one of the switch terminals of both switches.

For instance, FIG. 1 shows a switch terminal 8 of the prior art. The terminal includes a body portion, generally designated 10, having a solder foot 11 for connection, as by soldering, to an appropriate circuit trace on a printed circuit board. A contact spring arm, generally designated 12, extends from the body portion to a card-engaging portion, generally designated 13. A free end of the contact spring arm forms a contact portion, generally designated 14. Body portion 10 has toothed edges 15 for biting into the plastic material of a connector housing to fix the body portion to the housing, with contact spring arm 12 free to flex relative to the body portion.

In operation of the switch terminal 8 in FIG. 1, when a memory card is inserted into the corresponding connector within which the terminal is mounted, a side of the memory card engages the card-engaging portion 13 and biases contact portion 14 outwardly in the direction of arrow “A”, whereupon the contact portion engages the contact portion of an associated switch terminal (not shown).

Problems are encountered with prior art switch terminals such as terminal 8 in FIG. 1. Specifically, with contact portion 14 being at the extreme distal end of contact spring arm 12, card-engaging portion 13 is inside the contact portion, i.e., closer to the fulcrum defined by body portion 15. Therefore, the moment arm from the body portion to the card-engaging portion is relatively short and reduces the elasticity of the spring arm. With the short moment arm, excessive forces often are created against the side of the memory card by the card-engaging portion. The elasticity of the arm cannot be increased simply by narrowing the width of the spring arm, because this would weaken the arm and it would have a tendency to twist, deform or break. The arm cannot simply be lengthened to increase the elasticity of the arm, because there are definite restrictions on just how long the switch terminal can be within the constraints of the overall connector package.

The present invention is directed to solving these problems.

### SUMMARY OF THE INVENTION

An object, therefore, of the invention is to provide a new and improved switch terminal for a memory card connector.

In the exemplary embodiment of the invention, a memory card connector includes an insulative housing having a rear terminal-mounting section and at least one side wall section extending forwardly from one end of the rear section and defining a card-receiving space therebetween. A first switch terminal has a body portion fixed in a first slot in the housing. A contact spring arm is cantilevered from the body portion. A card-engaging portion is located at a free end of the contact spring arm and is exposed in the card-receiving space for engaging by a memory card inserted thereinto. A first contact portion is bent back behind the card-engaging portion. A second switch terminal has a body portion fixed in a second mounting slot in the housing and includes a contact spring arm extending from the body portion to a second contact portion. A third switch terminal has a body portion fixed in a third mounting slot in the housing. The third terminal is a “common” terminal and has a pair of contact spring arms with a pair of third contact portions engageable by the first and second contact portions of the first and second switch terminals, respectively, in response to inserting the memory card into the card-receiving space.

As disclosed herein, at least the first switch terminal is stamped and formed of sheet metal material. The body portion of the first switch terminal is generally planar. The contact spring arm is generally flat, as an extension of the planar body portion. The card-engaging portion is generally convex and presents a rounded surface for engagement by the memory card. In the preferred embodiment, the card-engaging portion is triangulated, with a pair of straight sections forming an apex at the rounded surface. The first contact portion has a rounded protrusion presenting a positive contact point for engaging one of the third contact portions of the third switch terminal.

Other features of the invention include a soldering portion at a bottom side of the body portion of the first switch terminal for connection to an appropriate circuit trace on a printed circuit board. The soldering portion is at a bottom side of the body portion, and the contact spring arm is cantilevered from a top side of the body portion. A locking tab is formed out of the body portion for interengagement with a locking shoulder on the housing.

The insulative housing includes a locating member for engaging a portion of the first switch terminal to limit the extent that the contact spring arm of the first terminal can deflect into the card-receiving space. The locating member engages the first contact portion of the first switch terminal and acts as an anti-overstress means therefor.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a switch terminal for a memory card connector, according to the prior art and as described in the Background, above;

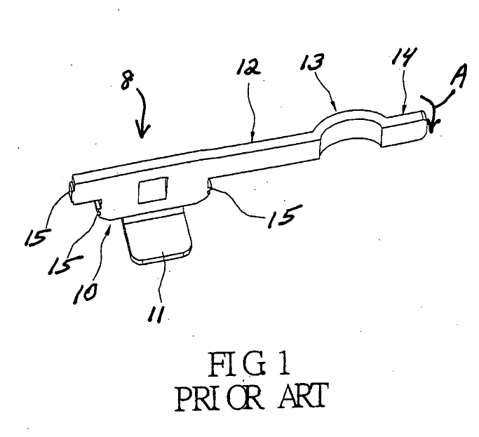

FIG. 2 is perspective view of a memory card connector according to the invention, with the switch terminals lifted from the connector housing;

FIG. 3 is a view similar to that of FIG. 2, with the switch terminals mounted in the housing;

FIG. 4 is a top plan view of the connector, with the switch terminals mounted in the housing;

FIG. 5 is an enlarged perspective view of the one switch terminal according to the invention; and

FIG. 6 is a fragmented perspective view of the area of the housing within which the switch terminals are mounted.

### DETAILED DESCRIPTION OF THE PREFERRED EMBODIMENT

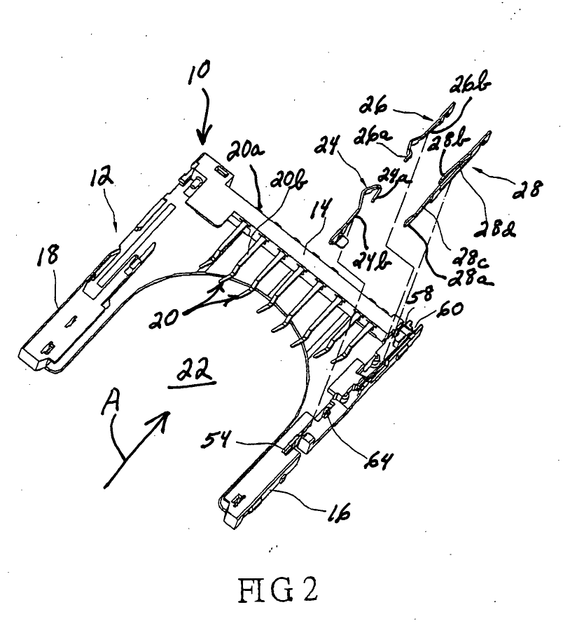

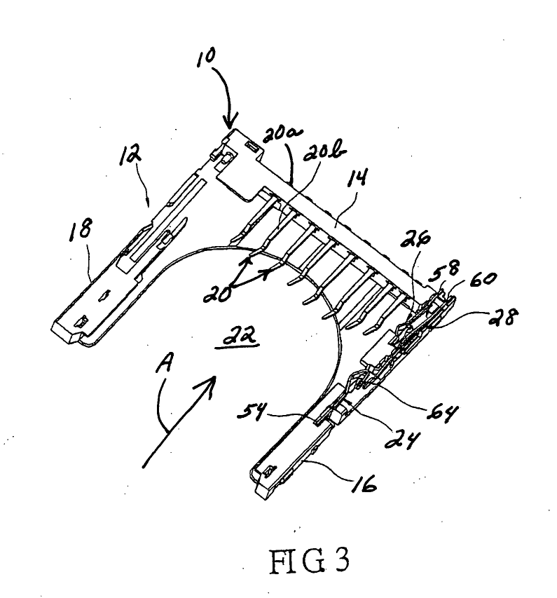

Referring to the drawings in greater detail, and first to FIGS. 2-4, the invention is embodied in a memory card connector, generally designated 10, which includes an insulative housing, generally designated 12, which has a generally U-shaped configuration. The housing includes a rear terminal-mounting section 14 and at least one side wall section 16 extending forwardly from one end of the rear section. With the U-shaped configuration, a second side wall section 18 extends forwardly form the opposite end of the rear section. However, some memory card connectors have generally L-shaped configurations, wherein a single side wall section 16 projects forwardly of the rear section.

A plurality of connector terminals, generally designated 20, are mounted through rear section 14 of the housing. The connector is adapted for mounting on a printed circuit board, and terminals 20 have tail portions 20a for connection, as by soldering, to appropriate circuit traces on the printed circuit board. The terminals have contact portions 20b projecting forwardly of rear section 14 into a card-receiving space 22 defined between side wall sections 16 and 18 and in front of rear section 14. A memory card (not shown) is inserted into the card-receiving space in the direction of arrow “A”. The memory card has a contact array for engaging contact portions 20b of terminals 20.

As stated in the Background, above, some memory card connectors are provided with a write-protection function by means of a pair of switch terminals. Some memory card connectors are provided with a card detector function also by means of a pair of switch terminals. Connector 10 is provided with a plurality of switch terminals which effect both the write-protection function as well as the card detector function.

Specifically, a first switch terminal, generally designated 24, and a second switch terminal, generally designated 26, are operatively associated with a third or □common□ switch terminal, generally designated 28. First switch terminal 24 has a contact portion 24a at the free end of a contact spring arm 24b. Second switch terminal 26 has a contact portion 26a at the free end of a contact spring arm 26b. Third or “common” switch terminal 28 has a pair of contact portions 28a and 28b at the free ends of a pair of contact spring arms 28c and 28d, respectively, for engaging contact portions 24a and 26a, respectively, of first and second switch terminals 24 and 26, respectively.

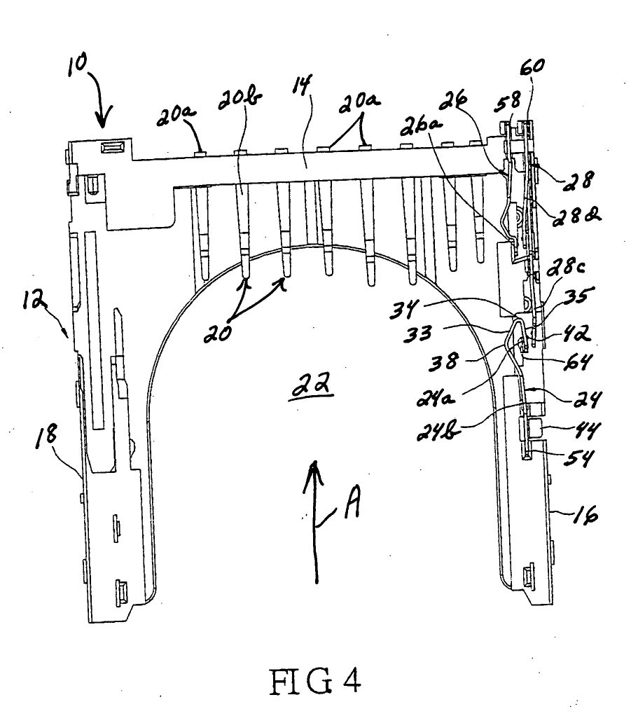

As can be understood best by referring to FIG. 4, when a memory card is inserted into card-receiving space 22 in the direction of arrow “A”, a side edge of the card sequentially engages first switch terminal 24 and then switch terminal 26. This sequentially biases the contact portion 24a of first terminal 24 into engagement with the contact portion 28a of common terminal 28. The card then biases contact portion 26a of second switch terminal 26 into engagement with contact portion 28b of common terminal 28. First switch terminal 24 can be considered the “write-protection” terminal, and second switch terminal 26 can be considered the card detector terminal. Therefore, movement of the memory card into card-receiving space 22, effectively actuates the write-protection of the connector afforded by first switch terminal 24 engaging common switch terminal 28, and then effectively actuates the card detector function of the connector afforded by second switch terminal 26 engaging the common switch terminal as the memory card reaches its fully inserted position.

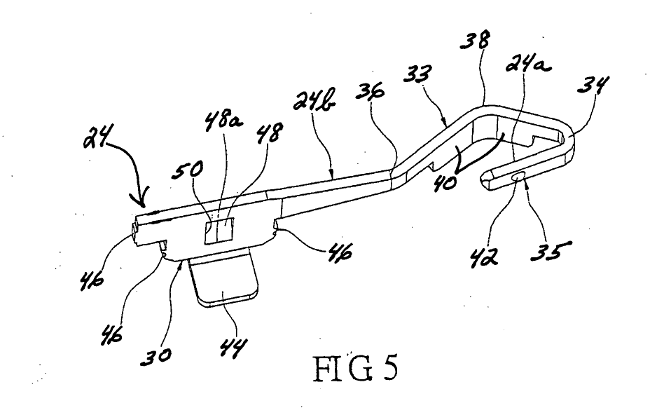

FIG. 5 shows the details of first switch terminal 24 according to the invention. Of course, second switch terminal 26 could be similarly configured and extend in the opposite direction as a mirror image of terminal 24.

Specifically, first switch terminal 24 includes a body portion, generally designated 30, and a contact spring arm, generally designated 24b, cantilevered from the body portion. A card-engaging portion, generally designated 33, is formed at a free end of the contact spring arm. A contact means, generally designated 35, is bent back, as at 34, behind the contact engaging portion.

The switch terminals of connector 10, including first switch terminal 24 in FIG. 5, preferably are stamped and formed of conductive sheet metal material. Therefore, body portion 30 of the first switch portion is generally planar. Contact spring arm 24b is generally flat, as an extension of the planar body portion. Card-engaging portion 33 is bent, as at 36, from a free end of the contact spring arm. The card-engaging portion is generally convex and presents a rounded surface 38 for engagement by a memory card. In the preferred embodiment, as shown, the card-engaging portion is triangulated, with a pair of straight sections 40 forming an apex at rounded surface 38. Contact means 35 includes contact portion 24a, described above, and bent back over and behind the card-engaging portion. The contact portion is generally parallel to contact spring arm 24b. A rounded protrusion 42 is formed from contact portion 24a to present a positive contact point for engaging contact portion 28a of common terminal 28.

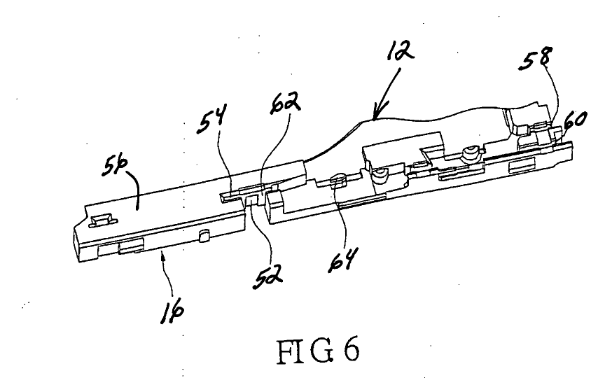

Connector 10 is adapted for mounting on a printed circuit board, as described above, with tail portions 20a (FIGS. 2-4) of connector terminals 20 soldered to appropriate circuit traces on the board. To that end, first switch terminal 24 (FIG. 5) includes a soldering portion or foot 44 for connection, as by soldering, to an appropriate circuit trace on the printed circuit board. The soldering portion projects at a right-angle outwardly from the bottom of the body portion, and contact spring arm 24b is cantilevered from the top of the body portion. A plurality of teeth 46 are stamped into the side edges of the body portion for skiving into the plastic material of the housing to fix the body portion therein. In addition, a locking tab 48 is stamped and formed out of an opening 50 in the body portion. The locking tab has a free edge 48a which engages a locking shoulder 52 (FIG. 6) on the housing.

FIG. 6 shows the area of housing 12 within which switch terminals 24, 26 and 28 are mounted. Body portion 30 of first switch terminal 24 is mounted in a first mounting slot 54 in a top surface 56 of side wall section 16 of the housing. Second switch terminal 26 has a body portion mounted in a second mounting slot 58. The third or common switch terminal 28 has a body portion mounted in a mounting slot 60. It can be seen that locking shoulder 52, described above, is formed on an inside surface 62 of first mounting slot 54.

Still referring to FIG. 6, another feature of the invention is the provision of an anti-overstress locating member or boss 64 on side wall section 56 of housing 12 as shown in FIG. 6. As shown best in FIG. 4, locating member 64 is positioned immediately inside contact portion 24a of the first switch terminal. This prevents the first switch terminal from being bent excessively into card-receiving space 22 which might over-stress contact spring arm 24b of the terminal.

With contact portion 24a bent back toward body portion 30 behind card-engaging portion 38, contact spring arm 24b can be made longer within any given space. This significantly increases the elasticity or resiliency of contact spring arm 24b which is cantilevered from the body portion.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
an insulative housing having a rear terminal-mounting section and at least one side wall section extending forwardly from one end of the rear section and defining a card-receiving space therewith;
a first switch terminal having a body portion fixed in a first slot in the housing, a contact spring arm cantilevered from the body portion, a card-engaging portion at a free end of the contact spring arm and exposed in the card-receiving space for engagement by a memory card inserted thereinto, and a first contact portion bent back behind the card-engaging portion;
a second switch terminal having a body portion fixed in a second mounting slot in the housing, and a contact spring arm extending from the body portion to a second contact portion; and
a third switch terminal having a body portion fixed in a third mounting slot in the housing, and a pair of contact spring arms having a pair of third contact portions engageable by the first and second contact portions of the first and second switch terminals, respectively, in response to inserting the memory card into the card-receiving space.

2. The memory card connector of claim 1 wherein at least said first switch terminal is stamped and formed of sheet metal material.

3. The memory card connector of claim 1 wherein the body portion of said first switch terminal is generally planar.

4. The memory card connector of claim 3 wherein the contact spring arm of said first switch terminal is generally flat, as an extension of the planar body portion.

5. The memory card connector of claim 1 wherein the card-engaging portion of said first switch terminal is generally convex and presents a rounded surface for engagement by the memory card.

6. The memory card connector of claim 5 wherein said card-engaging portion is triangulated with a pair of straight sections forming an apex at said rounded surface.

7. The memory card connector of claim 1 wherein the first contact portion of said first switch terminal includes a rounded protrusion presenting a positive contact point for engaging one of the third contact portions of the third switch terminal.

8. The memory card connector of claim 1 wherein the body portion of said first switch terminal has a soldering portion at a bottom side thereof for connection to an appropriate circuit trace on a printed circuit board.

9. The memory card connector of claim 8 wherein the contact spring arm of said first switch terminal is cantilevered from a top side of the body portion.

10. The memory card connector of claim 1 wherein the body portion of said first switch terminal includes a locking tab for interengagement with a locking shoulder on the housing.

11. The memory card connector of claim 1 wherein said housing includes a locating member for engaging a portion of the first switch terminal to limit the extent that the contact spring arm of the first terminal can deflect into the card-receiving space.

12. The memory card connector of claim 11 wherein said locating member engages the first contact portion of the first switch terminal.

13. A memory card connector, comprising:
an insulative housing having a rear terminal-mounting section and at least one side wall section extending forwardly from one end of the rear section and defining a card-receiving space therewith;
a first switch terminal stamped and formed of sheet metal material and having a generally planar body portion fixed in a first slot in the housing, a contact spring arm cantilevered from the body portion and being generally flat as an extension of the planar body portion, a card-engaging portion at a free end of the contact spring arm and exposed in the card-receiving space for engagement by a memory card inserted thereinto, the card-engaging portion being generally convex and presenting a rounded surface for engagement by the memory card, and a first contact portion bent back behind the card-engaging portion;
a second switch terminal having a body portion fixed in a second mounting slot in the housing, and a contact spring arm extending from the body portion to a second contact portion; and
a third switch terminal having a body portion fixed in a third mounting slot in the housing, and a pair of contact spring arms having a pair of third contact portions engageable by the first and second contact portions of the first and second switch terminals, respectively, in response to inserting the memory card into the card-receiving space.

14. The memory card connector of claim 13 wherein said card-engaging portion is triangulated with a pair of straight sections forming an apex at said rounded surface.

15. The memory card connector of claim 13 wherein the first contact portion of said first switch terminal includes a rounded protrusion presenting a positive contact point for engaging one of the third contact portions of the third switch terminal.

16. The memory card connector of claim 13 wherein the body portion of said first switch terminal has a soldering portion at a bottom side thereof for connection to an appropriate circuit trace on a printed circuit board.

17. The memory card connector of claim 16 wherein the contact spring arm of said first switch terminal is cantilevered from a top side of the body portion.

18. The memory card connector of claim 13 wherein the body portion of said first switch terminal includes a locking tab for interengagement with a locking shoulder on the housing.

19. The memory card connector of claim 13 wherein said housing includes a locating member for engaging a portion of the first switch terminal to limit the extent that the contact spring arm of the first terminal can deflect into the card-receiving space.

20. The memory card connector of claim 13 wherein said locating member engages the first contact portion of the first switch terminal.

21. The memory card of claim 13 wherein said first contact portion is bent back behind the contact-engaging portion of the first terminal generally parallel to the contact spring arm.

22. A memory card connector, comprising:
an insulative housing defining a card-receiving space;
a first terminal having a body portion fixed to the housing, a contact spring arm cantilevered from the body portion, a card-engaging portion at a free end of the contact spring arm and exposed in the card-receiving space for engaging by a memory card inserted thereinto, and a first contact portion bent back behind the card-engaging portion; and
a second terminal mounted on the housing and having a second contact portion for engagement by the first contact portion of the first terminal in response to inserting the memory card into the card-receiving space.

23. The memory card connector of claim 22 wherein at least said first switch terminal is stamped and formed of sheet metal material.

24. The memory card connector of claim 23 wherein the body portion of said first switch terminal is generally planar.

25. The memory card connector of claim 24 wherein the contact spring arm of said first switch terminal is generally flat, as an extension of the planar body portion.

26. The memory card connector of claim 22 wherein the card-engaging portion of said first switch terminal is generally convex and presents a rounded surface for engagement by the memory card.

27. The memory card connector of claim 26 wherein said card-engaging portion is triangulated with a pair of straight sections forming an apex at said rounded surface.

28. The memory card connector of claim 7 wherein the first contact portion of said first switch terminal includes a rounded protrusion presenting a positive contact point for engaging one of the third contact portions of the third switch terminal.
